(19) United States
(12) Patent Application Publication
(10) Pub. No.: US 2003/0012453 A1
(43) Pub. Date: Jan. 16, 2003

(54) Method for removing defects from images

(75) Inventors: Alexei Nikolaevich Kotlikov, St. Petersburg (RU); Krzysztof Antoni Zaklika, Saint Paul, MN (US)

Correspondence Address: MARK A. LITMAN & ASSOCIATES, P.A., York Business Center, Suite 205, 3209 W. 76th St., Edina, MN, 55402, US

(73) Assignee: JASC Software, Inc.

(21) Appl. No.: 09/900,506

(22) Filed: Jul. 6, 2001

(51) Int. Cl. G06T 5/00; H04N 1/409; G06T 7/00; H04N 1/58; G06K 9/36

(52) U.S. Cl. 382/275; 382/112; 382/282; 382/162

(57) ABSTRACT

A method of removing an object from a digital image comprising,

displaying a digital image derived from digital image data,

overlaying a virtual frame to surround a sub-region of the digital image that contains at least a part of the object and a portion of the digital image that does not comprise the object,

identifying the defect or object to be removed by apportioning the virtual frame into object and non-object regions,

modifying the digital data to amend data relating to object regions so that the data more closely resembles data of non-object regions,

the step of modifying the digital data including combining noise into the digital data of the object.

### BACKGROUND OF THE INVENTION

1. Field of the Invention

This invention relates to the detection and elimination of defects from images, particularly in the field of digital imaging, and the use of computer assisted programs for removing defects such as scratches in images.

2. Background of the Art

Digital imaging has become widespread among both commercial and private consumers. With the advent of inexpensive high quality scanners, many old photographs are being converted to digital form for storage and reprinting. These images can often have scratches, stains, creases and the like because of age, improper storage or poor handling. In view of the historical or sentimental value attaching to such images, there is a strong desire and need to provide tools to eliminate or reduce these kinds of defects.

Conventional image editing software, such as PhotoStyler® 2.0 (Aldus Corporation, 411 First Avenue South, Seattle, Wash. 98104), Photoshop® 5.5 (Adobe Systems Incorporated, 345 Park Avenue, San Jose, Calif. 95110-2704) or Paint Shop Pro® 7 (Jasc Software, Inc., 7905 Fuller Road, Eden Prairie, Minn., 55344) provides brush tools for modifying images. One particular brush is known as the clone brush, which picks a sample from one region of the image and paints it over another. Such a brush can be used effectively to paint over a scratch or other defect in the image. For many inexperienced consumers, however, it is difficult to use this tool since the operator must simultaneously watch the movement of the source region and the region being painted. Considerable dexterity and coordination is required, and experience is needed to set brush properties in such a way as to produce a seamless correction.

Another image editor, PhotoDraw® 2000 (Microsoft Corporation, One Microsoft Way, Redmond, Wash. 98052-6399), provides among its “Touch Up” tools a “Clone Paint” option and also a “Remove Scratch” option. The latter involves dragging out a rectangle to surround a defect to be removed and then invoking correction. Although this tool will sometimes remove a defect, it is not generally satisfactory. Correction of defects with poorly defined or soft edges is erratic and incomplete. This problem is exacerbated in the presence of any image noise. Moreover, the corrected area has an inappropriately smooth look, which makes the corrected area stand out in images where the defect lies over noise or even slight, fine scale texture. Although the tool offers ease of use, it cannot cope with a large variety of the situations commonly encountered in consumer images.

There remains, therefore, a need for an easy to use tool for removing defects from digital images.

### SUMMARY OF THE INVENTION

It is one aspect of this invention to provide an easy to use method for removing defects or other objects from an image in a relatively seamless fashion.

The method of removing a defect or object from an image comprises,

displaying a digital image derived from digital image data,

providing a means to specify a sub-region of the digital image that contains at least a portion of the object to be removed and a portion of the digital image that does not comprise the object,

classifying the sub-region into object and non-object digital data,

and amending the object data to more closely resemble the data of non-object regions.

A preferred practice of the invention includes the detection of the defect or object in a perceptual color space and replacement of the defect by progressive interpolation, with admixture of an appropriate level of noise determined from the image in the region of the defect or object.

### BRIEF DESCRIPTION OF THE FIGURES

FIG. 1 shows different styles of defect area definition boxes. Styles labeled (a) are appropriate for larger defects and styles labeled (b) are appropriate for smaller defects. Styles of type (1) have flat ends and styles of type (2) have pointed ends.

FIG. 2 shows the utility of object area definition boxes with pointed ends when a defect is in proximity to an object edge.

FIG. 3 shows a pixel grid superposed on a defect area definition box and defines pixel positions used in the search for a defect.

FIG. 4 shows an identified defect within the defect area definition box along with the region used to estimate image noise in the vicinity of the defect and the pixel positions used in the noise estimation.

### DETAILED DESCRIPTION OF THE INVENTION

This invention is particularly applicable to operations on digital images. A digital image comprises a collection of picture elements or pixels arranged on a regular grid. A gray scale image is represented by a channel of specific brightness values at individual pixel locations. Such a channel may also be represented as a color palette, for example a palette containing 256 shades of gray. A color image contains several channels, usually three or four channels, to describe the color at a pixel. For example, there may be red, green and blue (RGB) channels, or cyan, magenta, yellow and black (CMYK) channels. Each channel again contains brightness values representing the amount of color at each pixel. A color image may also be represented in palettized form. A palettized image is associated with a restricted palette of colors (e.g., 16 or 256 colors) and instead of pixels carrying color values directly (e.g., as a triplet of red, green and blue values) each pixel has instead an index into the color palette associated with the image by means of which the actual color values of the pixels can be retrieved

In general terms the practice of the invention provides a method of removing an object from an image comprising,

displaying a digital image derived from digital image data,

providing a means to specify a sub-region of the digital image that contains at least a portion of the object to be removed and a portion of the digital image that does not comprise the object,

classifying the sub-region into object and non-object digital data,

and amending the object data to more closely resemble the data of non-object regions.

A preferred practice of the invention involves use of a perceptual color space for the classification of image data into object and non-object regions, i.e., a color space in which the representation of color accords well with human perception. This preferred practice of the invention provides a method of removing an object from an image comprising,

displaying a digital image derived from digital image data,

providing a means to specify a sub-region of the digital image that contains at least a portion of the object to be removed and a portion of the digital image that does not comprise the object,

classifying the sub-region into object and non-object digital data in a perceptual color space,

and amending the object data to more closely resemble the data of non-object regions.

Another preferred practice of the invention includes the addition of noise during amending of the object data to more closely resemble the data of non-object regions. It is particularly preferred that the amount of noise to be added is estimated from the image data, especially from the image data in the vicinity of the object being removed. This preferred practice of the invention provides a method of removing an object from an image comprising,

displaying a digital image derived from digital image data,

providing a means to specify a sub-region of the digital image that contains at least a portion of the object to be removed and a portion of the digital image that does not comprise the object,

classifying the sub-region into object and non-object digital data,

and amending the object data to more closely resemble the data of non-object regions wherein the amendment includes combining noise into the digital data amending the object region.

An effective and preferred practice of the invention includes the specification of a sub-region of the image containing at least some object and non-object data by means of a virtual frame controlled, for example, by means of a cursor and/or keyboard keys. This preferred practice of the invention provides a method of removing an object from an image comprising,

displaying a digital image derived from digital image data,

overlaying a virtual frame to surround a sub-region of the digital image that contains at least a portion of the object to be removed and a portion of the digital image that does not comprise the object,

classifying the sub-region into object and non-object digital data by apportioning the virtual frame into object and non-object regions,

and amending the object data to more closely resemble the data of non-object regions.

These elements of the invention are explained more fully in the detailed description that follows.

To remove a defect or object in the image, the operator in the present invention is required only to roughly indicate the location of the defect as a region of interest. Exact isolation of the defect is not required and, indeed, is contraindicated since it represents unnecessary labor. However, it is required that a sufficiently large area be defined to include at least some of the background surrounding the defect as well as the defect itself. It is preferred that other objects be excluded, as best as is possible, from the region of interest to prevent them also being interpreted as objects to be removed. Not all the defect(s) or object(s) to be removed need be indicated at one time. The defect or object may, for instance be specified in sections or portions to better fit the total correction to the shape of the defect. Once this has been done, the method of the invention will then delineate the defect automatically.

The classification of pixels in the region defined by the operator may be conducted in any color space. For example, in the case of a gray scale image the classification may use the original gray scale data of the image or, alternatively, a transformation of the data to another color space providing a brightness representation, for example one that is non-linear with respect to the original gray scale representation. In the case of color images it is most useful to utilize a color space with a brightness component and orthogonal chrominance components, especially those where an approximately opponent color representation is used. Examples of such color spaces include YIQ, YUV, YCbCr, YES, ATD and the like. However, regardless of the original gray scale or color representation of the image, the search for the outer boundaries of the defect is preferably conducted in a special color space. This space is a perceptual color space, meaning that the underlying mathematical description substantially represents the human perception of color. Such a color space must support, at least approximately, the concept of a just noticeable difference or minimum perceptible difference in color. This means that a distance can be defined in the color space that, for small perceived differences between two colors, substantially accords with the statistically aggregated ability of human observers to determine whether the colors are different or not and that this distance is substantially uniform throughout the color space. Such a color space has three dimensions, usually corresponding to lightness and to the chrominance of two opponent colors, or to lightness, hue and chroma, or their equivalents. The distance corresponding to a just noticeable difference in color may be defined separately along each of the axes of the color space, or as a distance along one axis coupled with a distance in an orthogonal plane or as a single distance measured within the volume of the color space. Suitable color spaces are color difference systems such as the CIE L*u*v* and CIE L*a*b* color spaces as described in G. Wyszecki and W. S. Stiles, “Color Science—Concepts and Methods, Quantitative Data and Formulae”, Wiley, New York, 1982. Other color suitable color spaces are color appearance systems such as those described in M. D. Fairchild, “Color Appearance Models”, Prentice-Hall, New York, 1998. Examples include: the Nayatani color model (Y. Nayatani, Color Res. and Appl., 20, 143 (1995)); the Hunt color model (R. W. G. Hunt, Color Res. and Appl., 19, 23 (1994)); the LLAB color model (R. Luo, Proc. SPIE, 2658, 261 (1996)); the RLAB model (M. D. Fairchild, Color Res. and Appl., 21, 338 (1996)); the ZLAB model (M. D. Fairchild, Proceedings of the CIE Expert Symposium '97 on Colour Standards for Image Technology, CIE Pub. x014, 89-94 (1998)); the IPT model (F. Ebner.and M. D. Fairchild, Proc. 6th IS&T/SID Color Imaging Conf., 8 (1998)); the ATD model (S. L. Guth, Proc. SPIE, 2414, 12 (1995)); the Granger adaptation of ATD as disclosed in U.S. Pat. No. 6,005,968; and the CIECAM97s model described in CIE Pub. 131 (1998). Additional useful color spaces include those that take spatial variation of color into account, such as S-CIELAB (X. Zhang and B. A. Wandell, J. Soc. Information Display, 5, 61 (1997)). Color order systems are designed to represent significantly larger color differences than those that are just noticeable. However, they can be manipulated to provide approximations of the just noticeable difference. Examples of such color order systems include: the Munsell system (R. S. Berns and F. W. Billmeyer, Color Res. and Appl., 21, 163 (1996)); the Optical Society of America Uniform Color Scale (D. L. MacAdam, J. Opt. Soc. Am., 64, 1691 (1974)); the Swedish Natural Color System (Swedish Standard SS 0191 02 Color Atlas, Second Ed., Swedish Standards Institution, Stockholm, 1989); http://www.ncscolour.com/); and the Deutches Institut für Normung system (M. Richter and K. Witt, Color Res. and Appl., 11, 138 (1984)). Of these, the CIE L*u*v* and CIE L*a*b* color spaces are preferred since they offer sufficient accuracy in a simple implementation and are amenable to rapid color transformation from the original image space by use of a look-up table. Of these, CIE L*a*b* is especially preferred.

The search for the defect or object to be removed may be conducted in a number of ways. The purpose of the search is to categorize pixels in the region of interest into those that belong to the category of defect or object to be removed and into a category of those objects that do not need to be removed. Any conventional classification algorithm may be used to this end. Examples of such algorithms may be found in T.-S. Lim, W.-Y. Loh and Y.-S. Shih, Machine Learning Journal, 40, 203 (2000), and include categories such as decision tree approaches, rule-based classifiers, belief networks, neural networks, fuzzy and neuro-fuzzy systems, genetic algorithms, statistical classifiers, artificial intelligence systems and nearest neighbor methods. These techniques may employ methodologies such as principal component analysis, support vector machines, discriminant analysis, clustering, vector quantization, self-organizing networks and the like. The various classification methods may be used either individually or in combination with each other. Other, simpler methods may also be used. For example, a preferred way is to search for the defect or object inwards along pixel rows or columns from the boundary of the region of interest defined by the operator. Whatever the exact search method, they are each generally based on the use of a perceptual metric for distinguishing the color of the defect or object from the color of the background surrounding the defect or object. This perceptual metric may be derived from a calibration table of any color space, especially an opponent color space, wherein are stored just noticeable differences in different regions of the color space. However, less labor is involved and more accuracy is achieved if a perceptual color space is used and this, therefore, is preferred. This metric can be in the form of a threshold, T, that is a function of the just noticeable distance, J. Preferably the threshold bears a proportional relationship to the just noticeable distance so:

T=A.J

The proportionality constant, A, may vary significantly depending on the needs of the application. A preferred range for A is from about 0.25 to about 20 and a more preferred range is from about 0.5 to about 10. An especially preferred range is from about 0.5 to 5.

When working in the CIE L*u*v or CIE L*a*b* color spaces or the majority of the color appearance spaces, color differences, ΔE*, may be represented as a Euclidean distance in the volume of the space. For example, this color difference in the CIE L*a*b* color space is given by:

ΔE*=([ΔL*]²+[Δa*]²+[Δb*]²)^{0.5}

and ΔL*=L*₁−L*₂, Δa*=a*₁−a*₂ and Δb*=b*₁−b*₂, where the two colors being compared are designated by the subscripts 1 and 2. Here, L* represents a lightness coordinate, a* represents an approximately green-red coordinate, and b* represents an approximately blue-yellow coordinate. The just noticeable difference in color is usually taken to be a ΔE* of unity. However, actual values have been found to range from about 0.5 to about 10 ΔE* units for various observers; consequently 2 or 3 units may be taken as an average value. The same color difference may be expressed in different terms as:

ΔE*_{LCH}=([ΔL*]²+[ΔC*]²+[ΔH*]²)^{0.5}

where ΔC* denotes a difference in chroma and ΔH* denotes a difference in hue. Chroma, C*, is defined as ([a*]²+[b*]²)^{0.5} while the hue difference ΔH* is defined as ([ΔE*]²−[ΔL*]²−[ΔC*]²)^{0.5}. It is usually sufficient to use color difference metrics such as ΔE* or ΔE*_{LCH}. However, if necessary, it is also possible to use modifications of these metrics designed to more closely represent human perception. The selection of these color difference metrics may be done by manual selection, manual selection from a table or within a predetermined range, automatic selection from a table, or the like. One example is the CIE94 color difference (CIE Publ. 116-95 (1995)) given by:

ΔE*₉₄=([ΔL*/k_{L}S_{L}]²+[ΔC*/k_{C}S_{C}]²+[ΔH*/k_{H}S_{H}]²)^{0.5}

where the S weighting factors are S_{L}=1, S_{C}=1+0.045C*₁₂, and S_{H}=1+0.015C*₁₂. The value of C*₁₂ may be taken as the geometric mean of the two chroma values being compared, while k_{L}, k_{C} and k_{H} may be taken as unity, or changed (manually or automatically) depending on deviation from standard viewing conditions. Another example of an improved metric is Color Measurement Committee formula (F. J. J. Clark, R. McDonald and B. Rigg, J. Soc. Dyers Color, 100, 128 (1984)) given by:

ΔE*_{CMC(l:c)}=([ΔL*/lS_{L}]²+[ΔC*/cS_{C}]²+[ΔH*/S_{H}]²)^{0.5}

where: S_{L}=0.040975 L*/(1+0.01765 L*) unless L*<16 when S_{L}=0.511; S_{C}=0.638+0.0638 C*₁₂/(1+0.0131 C*₁₂); S_{H}=(fT+1−f)S_{C}; and where h₁₂ is the mean hue angle of the colors being compared, f=([C*₁₂]⁴/{[C*₁₂]⁴+1900})^{0.5} and T=0.36+|0.4 cos(h₁₂+35)| unless h is between 164 and 345 degrees when T=0.56+|0.2 cos(h₁₂+168)|. For determining color differences, l:c is usually taken as 1:1 although it is also possible to manually or automatically use other values, for instance a l:c ratio of 2:1. It is generally accepted that in many cases ΔE*_{CMC(l:c)} gives slightly better results than ΔE*₉₄. While the above are formulas well know to practitioners of the art, modifications are possible. For instance, it may be desirable to reduce the contribution of lightness to the equation to compensate for a different illumination or condition of illumination of an object in an image. Such modifications are also within the scope of the invention. Distances need not be measured in Euclidean terms. For example, distance may be measured according to a Mahalanobis distance, or a city-block distance (also called the Manhattan or taxi-cab distance) or as a generalized Minkowski metric, for example, of the form ([ΔL*]^{p}+[ΔC*]^{p}+[ΔH*]^{p})^{1/p}, where p lies from 1 to infinity. The city block distance corresponds to p=1 and the Euclidean distance to p=2, while for many situations involving combinations of perceptual differences a value of p=4 is often effective.

After they have been defined, the defect or object pixels may be corrected by any method known in the art. For example, the pixel may be replaced by the average or weighted average of pixels in its neighborhood, preferably excluding other defect pixels. The output of a top hat or rolling ball filter may also be used. Non-linear filters such as the median filter or other rank leveling filters may be employed. Adaptive filters are another alternative, such as the double window modified trimmed mean filter described in “Computer Imaging Recipes in C’, H. R. Myler and A. R. Weeks, Prentice-Hall, 1993, p. 186ff. The defect may also be corrected by the use of morphological operations such as erosion or dilation, selected on the basis of the lightness or darkness of the defect relative to its surroundings. Combinations of these operations in the form of morphological opening and closing are also possible. The defect may also be removed by interpolation such as with linear interpolation or quadratic interpolation. Other interpolation methods, for example such as the trigonometric polynomial technique described on-line by W. T. Strohmer in “A Levinson-Galerkin algorithm for trigonometric approximation” at http://tyche.mat.univie.ac.at/papers/inpress/trigappr.html or the multivariate radial basis technique described on-line by H. Zatschler in “M4R Project—Radial Basis Functions” at http://www.doc.ic.ac.uk/˜hz3/m4rproject/m4rproject.html may also be used. Interpolation may also be accomplished by fitting a surface such as a plane or a parabola to the local intensity surface of the image. In color or multichannel images, information from a defective channel may be reconstructed using information from the remaining undamaged channels. The defect may also be repaired using the method of Hirani as described in A. N. Hirani and T. Totsuka, Proceedings of SIGGRAPH 96, 269-276 (1996). Alternatively the repair may be effected by inpainting as discussed in M. Bertalmio, G. Sapiro, V. Caselles, and C. Ballester, “Image Inpainting”, Preprint 1655, Institute for Mathematics and its Applications, University of Minnesota, December 1999 or by the more recent variational method described in C. Ballester, V. Caselles, J. Verdera, M. Bertalmio and G. Sapiro, “A Variational Model for Filling-In” available on-line at http://www.ceremade.dauphine.fr/reseaux/TMR-viscosite/preprints.html. Additional techniques are described in T. F. Chan and J. Shen, “Morphology Invariant PDE Inpaintings”, Computational and Applied Mathematics Report 01-15, UCLA, May 2001 and T. F. Chan and J. Shen, “Non-Texture Inpainting by Curvature-Driven Diffusions (CDD)”, Computational and Applied Mathematics Report 00-35, UCLA, September 2000.

Once the preliminary correction of the defect or object has been established as described above, the correction may be refined by the addition of noise. For example, if the defect is or object being removed is located on a uniform background the addition of noise is not required. However, when the background is busy or textured and contains much brightness or color variation the addition of noise is beneficial in disguising the correction. In such a case the amount or nature of the noise to be added is preferably adaptive and computed based on the brightness or color variation in the image. The noise may be of various kinds, for example additive noise, or multiplicative noise or impulsive noise. The noise may also be in a form representative of image texture. The noise may be added to the image after a preliminary correction is made on the image or may be incorporated in the correction, which only then is applied to the image. Whatever the type of noise that may be used, the appropriate form and amount of noise may be determined by analysis of undamaged image areas in the vicinity of the defect or object being removed. It is preferred that the analysis be performed in those areas of the region of interest defined by the user that are classified as not belonging to the defect or object to be removed. It is especially preferred that the analysis be performed using pixels that include those pixels that lie at a distance of about 2 to about 5 times the defect width from the edge of the defect or object to be removed. The color space used for the analysis may be the original color space of the image or that used for the classification or even a third color space. The analysis in this reference area may be a conventional statistical analysis making use of the average value of a channel, the mean absolute deviation from the average, the range of variation, the standard deviation, the skewness, the kurtosis and the like. These quantities may be calculated for the entire reference area or for several portions of the reference area. Analysis may also involve sweeping a window over the pixels of the reference area and computing statistics within the window. In addition to those statistics already mentioned, these may include computing the absolute channel difference between the center pixel and other pixels in the window, or the variance of these same pixels, or the absolute channel difference between adjacent neighbors, or the variance of adjacent neighbors. These quantities may also be calculated for more distant neighbors, such as second neighbors. Additionally, autocorrelation may be employed to analyze the noise. The noise in the reference area may also be characterized using methods of microtexture description. For example, the texture may be described by the following techniques: a gray level cooccurrence matrix (see R. M. Haralick, K. Shanmugam, and I. Dinstein, IEEE Trans. Systems Man and Cybernetics, 3, 610 (1973) and R. W. Conners, M. M. Trivedi, and C. A. Harlow, Computer Vision, Graphics and Image Processing, 25, 273 (1984)); a Gabor mask (see I. Fogel and D. Sagi, J. Biological Cybernetics, 61, 103 (1989)); a Gaussian Markov random field (see R. Chellappa and S. Chatterjee, IEEE Trans. Acoustics Speech and Signal Processing, 33, 959 (1985)); or a fractal dimension (see B. B. Chaudhuri, N. Sarkar, and P. Kundu, IEE Proceedings, 140, 233 (1993) and B. B. Chaudhuri and N. Sarkar, IEEE Trans. Pattern Analysis and Machine Intelligence, 17, 72 (1995)). Additionally, analysis using local binary patterns may be used, as described in T. Ojala, M. Pietikäinen and D. Harwood, Patt. Recognition, 29, 51 (1996), in M. Pietikäinen, T. Ojala and Z. Xu, Patt. Recognition, 33, 43 (2000) and in T. Ojala, K. Valkealahti, E. Oja and M. Pietikäinen, Patt. Recognition, 34, 727 (2001). The analysis of noise may be varied adaptively. For example, when the reference area contains very few pixels a simple statistical analysis may be performed, using only variance for instance, but when more pixels are available in a larger reference area a microtexture description may be computed.

The noise is desirably added to the corrected areas of the image so that defect corrections do not provide a region wherein the quality of the image in the correction is distinctly different from the general quality of the image. For example, if the image were an old, somewhat grainy photograph, replacing a defect area with a high resolution, grain-free replacement image quality area could be as likely to draw attention to the corrected area as would the original defect. By equilibrating the quality of the image data in the corrected area with the image quality in the general image, the correction would be less noticeable. The noise discussed here can relate to that type of image quality that must be equated or equalized between the area of correction and the general image.

The invention will be illustrated with a specific embodiment but it will be understood that as enabled above and by the ordinary skill of the artisan, wide variation in the practice of specific steps and embodiments is possible and contemplated within the scope of the invention. For clarity, the embodiment will be described as a sequence of steps. However, it is specifically intended and will be appreciated readily that the order of the steps may be changed and steps may be combined or split depending on the needs of the application.

### EXAMPLES

Step 1—Definition of the Region of Interest

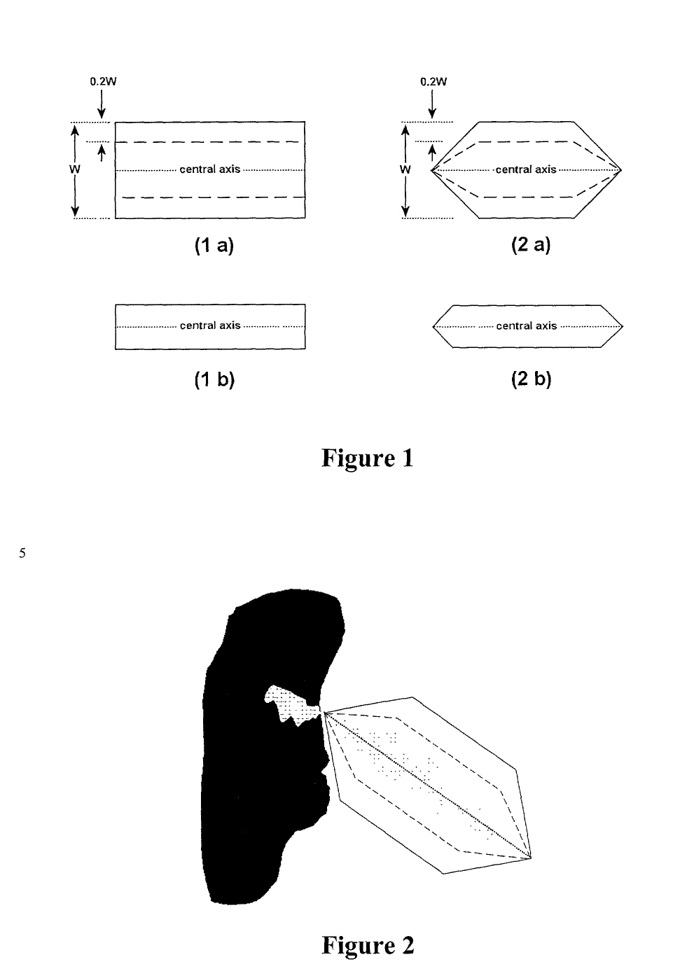

An image is received in RGB format (in red, green and blue color channels) and the operator defines the region of interest containing the defect or object to be removed, along with its surroundings, by dragging out a box such as (1a) or (1b) in FIG. 1 over a portion of the image using a pointing device such as a mouse. The box selects or defines an area where a defect is apparent where correction is desired. The box starts or is initiated on the image screen where the mouse button is first depressed and the box has a central axis corresponding to the dragging direction and a length dependent on the dragging distance. When the mouse button is released, the release indicates that the user is satisfied with the definition of the region of interest and the next step of the process may be executed. Prior to this, the origin point of the box may be repositioned with arrow keys and the end point may be repositioned by moving the mouse. The width of the box, as measured normal to the central axis, may also be changed by means of key presses or click and drag functions. The box may have one, two or more basic shapes (shown as the rectangular shape (1) and the irregular hexagonal shape (2) in FIG. 1), with at least two different appearances such as narrower shapes (a) and (b). Shape (1) is the default shape, while shape (2) may be selected for working with a defect that is at an angle to an object boundary in the image as shown in FIG. 2, where the defect is cross-hatched and the object and associated boundary is shown in black. The box has appearance 2(a) when it is 10 or more pixels wide, and appearance 2(b) when it is narrower. The two side strips of boxes (1a) and (2a) are each one fifth of the width of the entire box and are intended to be placed over a region of the image not containing the defect or object to be removed, while the center of the box is intended to contain the defect or object.

Step 2—Preparation for Classification

Once the operator has completed the definition of the region of interest, the box is rotated to place its central axis in a relatively horizontal position or parallel to a general geometric axis of the defect using sub-pixel sampling. For each pixel in the new orientation of the box, the coordinates of the source pixel in the original box are computed with sub-pixel accuracy and the colors of the four closest actual pixels are averaged to give the colors of the new pixel. Following rotation the colors in the box are converted to CIE L*a*b* using a look-up table. In this manner, within the box that has highlighted or defined the defect, the correction is restricted to pixels within the box. This also tends to gradate the correction, with non-defect areas within the box either remaining the same, contributing to the color/gray scale content of the area to be corrected, or itself also being ‘corrected’ to form a smoothing or gradation between the corrected area and the image outside the box.

Step 3—Classification

Classification is performed on a copy of the region of interest box that has been smoothed with a 3 pixel by 1 pixel averaging window oriented parallel to the central axis of the box. There are four approaches to classification depending on the width of the region of interest box.

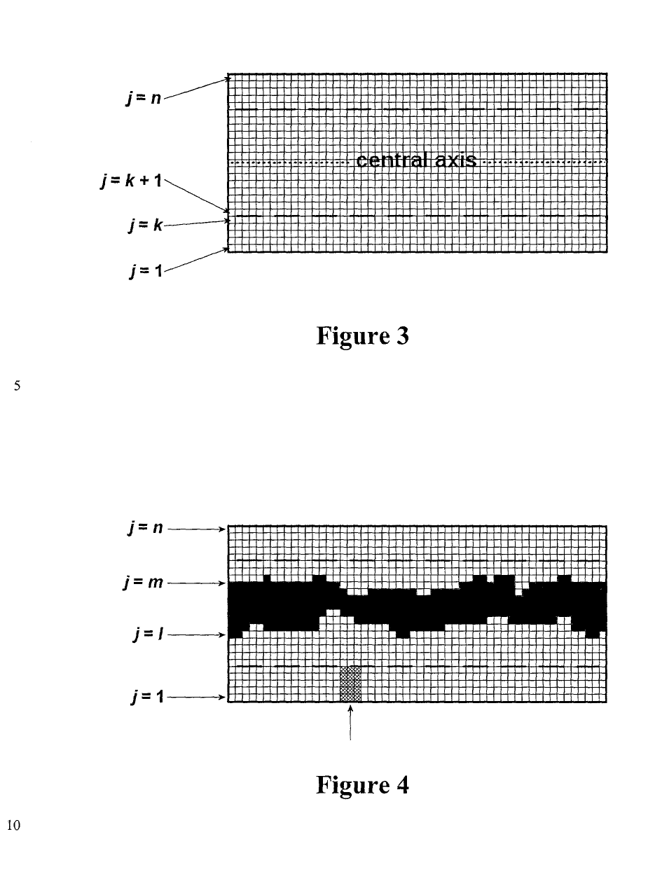

When the box is more than 20 pixels wide, the following procedure is employed. Referring to FIG. 3, each column of pixels is processed in succession as follows. Over the pixels j=1 to k of the side strip for the column of interest and the two adjacent columns on each side, average colors are computed as L*ₐᵥ₁, a*ₐᵥ₁ and b*ₐᵥ₁. A threshold, T₁, is determined for the column of interest by computing the noise standard deviation σ₁:

$${σ}_{1} = {( {\sum }_{j = 1}^{j = k} {\sum }_{i = - 1}^{i = + 1} {[ {L}_{a v 1}^{*} - {L}_{i , j}^{*} ]}^{2} / 3 k )}^{0.5}$$

again using the column of interest (i=0) and the two adjacent columns (i=−1 and i=+1). If σ₁ is less than 3, T₁ is set equal to 3; if σ₁ is greater than 3 but less than 10, T₁ is set equal to 6; otherwise T₁ is set equal to 10. Then, starting at j=k, ΔE*ⱼ, ΔE*ⱼ₊₁ and ΔΔE*_{j,j+1} are calculated as:

$$Δ {E}_{j}^{*} = {( {[ {L}_{a v 1}^{*} - {L}_{j}^{*} ]}^{2} + {[ {a}_{a v 1}^{*} - {a}_{j}^{*} ]}^{2} + {[ {b}_{a v1}^{*} - {b}_{j}^{*} ]}^{2} )}^{0.5}$$

$$Δ {E}_{j + 1}^{*} = {( {[ {L}_{a v 1}^{*} - {L}_{j + 1}^{*} ]}^{2} + {[ {a}_{a v1}^{*} - {a}_{j + 1}^{*} ]}^{2} + {[ {b}_{a v1}^{*} - {b}_{j + 1}^{*} ]}^{2} )}^{0.5}$$

$$ΔΔ {E}_{j , j + 1}^{*} = \vert Δ {E}_{j}^{*} - Δ {E}_{j + 1}^{*} \vert$$

and the value of ΔΔE*_{j,j+1} is compared to a threshold of T₁ ΔE* units. If the threshold is equaled or exceeded, then one border of the defect is located at j+1 and the search stops. Simultaneously, a similar search proceeds from the upper boundary of the box using independently determined values of L*ₐᵥ₂, a*ₐᵥ₂, b*ₐᵥ₂, σ₂ and T₂. If the threshold is not exceeded, j is incremented by one and the test is repeated from both directions. The search terminates either when the thresholds T₁ and T₂ are exceeded or when the searches from the two directions meet at a common pixel. The search process is repeated in the same fashion for every pixel column in the region of interest box illustrated in FIG. 3.

If the width of the region of interest box is from 10 to 20 pixels the search for the defect or object to be removed is conducted as follows. If there are n pixels per column in FIG. 3, a value of a penalty function P(j) within a pixel column is calculated for every j from 2 to n−1. The minimum of the penalty function is considered to be the center of the defect. Over the pixels i from 1 to j−1 average colors are computed as L*ₐᵥ₁, a*ₐᵥ₁ and b*ₐᵥ₁ and a mean deviation δ₁ is computed as:

$${δ}_{1} = {\sum }_{i = 1}^{i = j - 1} {( {[ {L}_{a v1}^{*} - {L}_{i}^{*} ]}^{2} + {[ {a}_{a v 1}^{*} - {a}_{i}^{*} ]}^{2} + {[ {b}_{a v 1}^{*} - {b}_{i}^{*} ]}^{2} )}^{0.5} / ( j - 1 )$$

Similarly a mean deviation δ₂ is computed from L*ₐᵥ₂, a*ₐᵥ₂ and b*ₐᵥ₂ in the interval i from j+1 to n. Then the penalty function is computed as:

P(j)=(δ₂+δ₁)/(1−0.4n|10.5n−j|)

and the value of j for which P(j) is a minimum is taken as the center of the defect. The defect is considered to extend from j−3 to j+3 or between the boundaries of the inner dashed box in FIG. 1, whichever is smaller.

If the width of the region of interest box is from 6 to 9 pixels, the box has the appearance (b) in FIG. 1 and the search for the defect or object to be removed is conducted as follows. Pixels of rows j=1 and j=n are considered not to contain the defect. If a pixel in row j=2 differs by ΔE* less than 3 from the pixel in row j=1 that lies in the same column, it too is considered not to contain the defect. Similarly, if a pixel in row j=n−1 differs by ΔE* less than 3 from the pixel in row j=n that lies in the same column, it is considered not to contain the defect. The remaining pixels within the column are assigned to the defect.

If the width of the region of interest box is 4 or 5 pixels the box has the appearance (b) in FIG. 1 and the search for the defect or object to be removed is conducted as follows. Pixels of rows j=1 and j=n are considered not to contain the defect. The remaining pixels from j=2 to j=n−1 are assigned to the defect. Box widths smaller than 4 pixels are not used.

Step 4—Preliminary Correction

At this stage, the virtual situation is as illustrated in FIG. 4, where in any given column, the defect or object to be removed (shown in black) extends from row j=l to row j=m, the positions of which are marked for the leftmost column. Preliminary correction is accomplished independently in each channel, C, of the original RGB channels of the image. A linear interpolation across the scratch region, F(j)=Aj+B, is computed by means of linear regression using pixels in columns 1 to l−1 and m+1 to n inclusive. Average channel values C₁ and C₂ are computed over the range of pixels from j=1 to j=l−1 and from j=m+1 to j=n respectively. The interpolation is blended into the image according to the following scheme:

a) In the interval 1 j<l−0.1w the pixels are left unchanged

b) In the interval l−0.1w j<l the new pixel value C′ⱼ is given by G(j)Cⱼ+[1−G(j)]F(j), where Cⱼ is the channel value at pixel j and G(j) is a weighting function

c) In the interval l j l+0.1w the new pixel value C′ⱼ is given by G(j)C₁+[1−G(j)]F(j)

d) In the interval l+0.1w<j<m−0.1w the new pixel value C′ⱼ is given by F(j)

e) In the interval m−0.1w j m the new pixel value C′ⱼ is given by H(j)C₂+[1−H(j)]F(j), where H(j) is a weighting function.

f) In the interval m<j m+0.1w the new pixel value C′ⱼ is given by H(j)Cⱼ+[1−H(j)]F(j)

g) In the interval m+0.1w<j n the pixels are left unchanged

The width of the region of interest box is w as show in FIG. 1 and an example of the weighting functions are given by:

G(j)=(j−l+0.1w)/0.2w

H(j)=(m−j+0.1w)/0.2w

It should be reminded that many various weighting functions may be used, with the specific algorithm or formula being chosen at the election of the operator or designer. Finally, the preliminarily corrected area is smoothed with an averaging filter having a 3 pixel by 1 pixel window oriented parallel to the central axis of the region of interest box. The smoothing takes place over the region between l−0.1w and m+0.1w of each column.

Step 5—Addition of Noise

The noise in the interval between l−0.1w and m+0.1w across a scratch is estimated as follows. For any given column in the box, such as the one marked with a vertical arrow in FIG. 4, an estimate of the noise variance in the crosshatched region was previously calculated as σ₁ in step 2. A similar noise variance σ₂ exists for the upper side strip of the region of interest box. The noise variance across the scratch is taken as σ=0.5(σ₁+σ₂). Uniform random noise in the interval [−2.55σ, 2.55σ] is generated and added to each of the channel values C′ⱼ determined in step 4. This noise is added to the region between l−0.1w and m+0.1w of each column. The rotation of the box performed in step 2 is then inverted using the same sub-pixel sampling technique. Finally, the contents of the corrected region of interest box are copied into the image.

Correction using a region of interest box such as (2a) or (2b) in FIG. 1 is accomplished in the same way as described above, with the exception that account is taken of the fact that the rotated columns of the box start and end at varying pixel rows as do the boundaries of the side strips of the box.

What is claimed:

1. A method of removing an object from a digital image comprising,
displaying a digital image derived from digital image data,
overlaying a virtual frame to surround a sub-region of the digital image that contains at least a part of the object and a portion of the digital image that does not comprise the object,
identifying the defect or object to be removed by apportioning the virtual frame into object and non-object regions,
modifying the digital data to amend data relating to object regions so that the data more closely resembles data of non-object regions,
the step of modifying the digital data including combining noise into the digital data of the object.

2. The method of claim 1 wherein the digital image data is provided in a format that describes a perceptual color space.

3. The method of claim 2 wherein the perceptual color space is selected from perceptual color spaces having a lightness component.

4. The method of claim 2 wherein the perceptual color space is selected from the group consisting of CIE L*u*v* and CIE L*a*b* color spaces.

5. The method of claim 2 wherein the object is a defect.

6. The method of claim 5 wherein the defect is digital data of a defect in an original image.

7. The method of claim 1 wherein the noise is estimated from image data in the vicinity of the object.

8. The method of claim 7 wherein the noise is estimated by a process comprising sampling image data from a non-object area.

9. The method of claim 3 wherein noise is estimated from image data in the vicinity of the object, and the noise is estimated by a process comprising sampling image data from a non-object area.

10. The method of claim 4 wherein noise is estimated from image data in the vicinity of the object, and the noise is estimated by a process comprising sampling image data from a non-object area.

11. The method of claim 9 wherein the perceptual color space is selected from the group consisting of the CIE L*a*b* color space and the CIE L*u*v* color space.

12. The method of claim 1 wherein object regions and non-object regions are designated by application of a threshold value for at least one component of the digital image data for a pixel.

13. The method of claim 1 wherein boundaries between object regions and non-object regions are determined by application of a threshold value for at least one component of the digital image data for a pixel.

14. The method of claim 1 wherein the modifying of the digital data to amend data relating to object regions so that the data more closely resembles data of non-object regions includes interpolation of non-defect data.

15. The method of claim 1 wherein the modifying of the digital data to amend data relating to object regions so that the data more closely resembles data of non-object regions includes linear combination of an interpolation of non-defect data and of original image data.

16. The method of claim 14 wherein the interpolation is linear interpolation.

17. The method of claim 1 wherein the noise is random noise.

18. The method of claim 4 wherein the noise is sampled from non-object regions in the vicinity of the object.

19. The method of claim 11 wherein boundaries between object regions and non-object regions are determined by application of a threshold value for at least one component of the digital image data for a pixel.

20. The method of claim 11 wherein the modifying of the digital data to amend data relating to object regions so that the data more closely resembles data of non-object regions includes interpolation of non-defect data.

21. The method of claim 11 wherein the modifying of the digital data to amend data relating to object regions so that the data more closely resembles data of non-object regions includes linear combination of an interpolation of non-defect data and of original image data.

22. The method of claim 20 wherein the interpolation is linear interpolation.

23. The method of claim 11 wherein the noise is random noise.

24. A computer and software in the memory of the computer that can execute the process of claim 1.

25. A computer and software in the memory of the computer that can execute the process of claim 4.

26. A computer and software in the memory of the computer that can execute the process of claim 11.

27. A computer and software in the memory of the computer that can execute the process of claim 19.
